(19) United States
(12) Patent Application Publication
(10) Pub. No.: US 2021/0342379 A1
(43) Pub. Date: Nov. 4, 2021

(54) METHOD AND DEVICE FOR PROCESSING SENTENCE, AND STORAGE MEDIUM

(71) Applicant: BEING BAIDU NETCOM SCIENCE AND TECHNOLOGY CO., LTD., Beijing (CN)

(72) Inventors: Shuai ZHANG, Beijing (CN); Lijie WANG, Beijing (CN); Ao ZHANG, Beijing (CN); Xinyan XIAO, Beijing (CN); Yue CHANG, Beijing (CN)

(21) Appl. No.: 17/375,236

(22) Filed: Jul. 14, 2021

(30) Foreign Application Priority Data
Dec. 25, 2020 (CN) 202011563713.0

(51) Int. Cl. G06F 16/35; G06F 40/211; G06F 16/31; G06F 16/33; G06N 3/04

(52) U.S. Cl. CPC G06F 16/35; G06F 40/211; G06N 3/04; G06F 16/3347; G06F 16/322

(57) ABSTRACT

The disclosure discloses a method and a device for processing a sentence, and a storage medium. The detailed implementation includes: during processing a sentence, obtaining a dependency tree graph among respective segmented words in the sequence of segmented words by performing a dependency parsing on a sequence of segmented words of the sentence, inputting the dependency tree graph and a word vector corresponding to each segmented word into a preset graph neural network to obtain an intermediate word vector of each segmented word in the sequence of segmented words, and obtaining a processing result of the sentence by performing the downstream task on the intermediate word vector of each segmented word.

### CROSS-REFERENCE TO RELATED APPLICATION

This application is based on and claims priority to Chinese Patent Application No. 202011563713.0 filed on Dec. 25, 2020, the content of which is hereby incorporated by reference in its entirety into this disclosure.

### FIELD

The disclosure relates to the field of computer technologies, and further to the field of artificial intelligence technologies such as deep learning and natural language processing, and more particularly to a method and a device for processing a sentence, and a storage medium.

### BACKGROUND

Presently, during performing natural language processing on a sentence, a downstream task of the natural language processing is generally processed based on a word vector (or a word embedding) of each segmented word in the sentence. However, a result obtained by processing the downstream task based on the word vector of each segmented word is inaccurate.

### SUMMARY

According to an aspect of the disclosure, a method for processing a sentence is provided. The method includes: obtaining a sentence to be processed; obtaining a downstream task to be executed for the sentence; obtaining a sequence of segmented words of the sentence by performing a word segmentation on the sentence; obtaining a dependency tree graph among respective segmented words in the sequence of segmented words by performing a dependency parsing on the sequence of segmented words; determining a word vector corresponding to each segmented word in the sequence of segmented words; inputting the dependency tree graph and the word vector corresponding to each segmented word into a preset graph neural network to obtain an intermediate word vector of each segmented word in the sequence of segmented words; and obtaining a processing result of the sentence by performing the downstream task on the intermediate word vector of each segmented word.

According to another aspect of the disclosure, an electronic device is provided. The electronic device includes: at least one processor and a memory. The memory is communicatively coupled to the at least one processor. The memory is configured to store instructions executable by the at least one processor. When the instructions are executed by the at least one processor, the at least one processor is caused to execute the method for processing the sentence according to the disclosure.

According to another aspect of the disclosure, a non-transitory computer readable storage medium having computer instructions stored thereon is provided. The computer instructions are configured to cause a computer to execute the method for processing the sentence according to embodiments of the disclosure.

It should be understood that, content described in the Summary is not intended to identify key or important features of embodiments of the disclosure, but not used to limit the scope of the disclosure. Other features of the disclosure will become apparent from the following description.

### BRIEF DESCRIPTION OF THE DRAWINGS

The accompanying drawings are used for better understanding the solution and do not constitute a limitation of the disclosure.

FIG. 1 is a flow chart illustrating a method for processing a sentence according to some embodiments of the disclosure.

FIG. 2 is a flow chart illustrating refinement for an action at block 106.

FIG. 3 is a flow chart illustrating refinement for an action at block 106.

FIG. 4 is a block diagram illustrating an apparatus for processing a sentence according to some embodiments of the disclosure.

FIG. 5 is a block diagram illustrating an apparatus for processing a sentence according to some embodiments of the disclosure.

FIG. 6 is a block diagram illustrating an apparatus for processing a sentence according to some embodiments of the disclosure.

FIG. 7 is a block diagram illustrating an electronic device capable of implementing a method for processing a sentence according to some embodiments of the disclosure.

### DETAILED DESCRIPTION

Description will be made below to exemplary embodiments of the disclosure with reference to accompanying drawings, which includes various details of embodiments of the disclosure to facilitate understanding and should be regarded as merely examples. Therefore, it should be recognized by the skilled in the art that various changes and modifications may be made to the embodiments described herein without departing from the scope and spirit of the disclosure. Meanwhile, for clarity and conciseness, descriptions for well-known functions and structures are omitted in the following description.

Description will be made below to a method and an apparatus for processing a sentence, and a storage medium according to embodiments of the disclosure with reference to accompanying drawings.

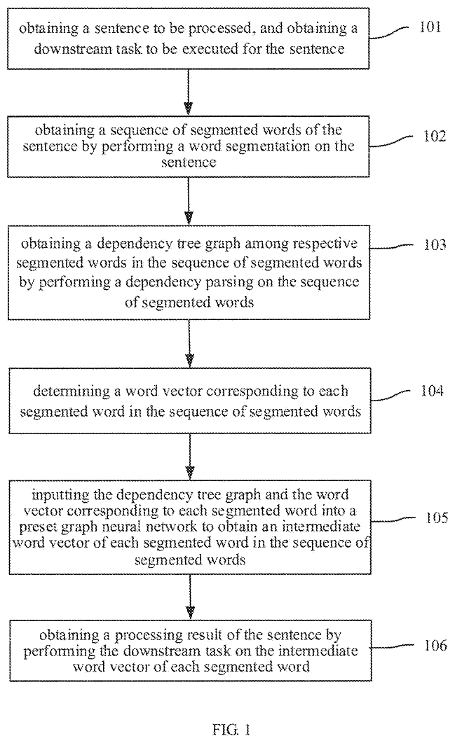

FIG. 1 is a flow chart illustrating a method for processing a sentence according to some embodiments of the disclosure.

As illustrated in FIG. 1, the method for processing the sentence includes the following.

At block 101, a sentence to be processed is obtained, and a downstream task to be executed for the sentence is obtained.

The sentence to be processed may be any sentence, which is not particularly limited in the embodiments of the disclosure.

An executive subject of the method for processing the sentence is an apparatus for processing a sentence. The apparatus may be implemented in a software and/or hardware way. The apparatus for processing the sentence in some embodiments may be configured in an electronic device. The electronic device may include, but be not limited to, a terminal device, a server, etc.

At block 102, a sequence of segmented words of the sentence is obtained by performing a word segmentation on the sentence.

In some embodiments, a possible implementation of the sequence of segmented words is performing the word segmentation on the sentence to obtain multiple candidate sequences of segmented words, performing a path search on each candidate sequence of segmented words based on a preset statistical language model to obtain a path score corresponding to the candidate sequence of segmented words, and selecting a candidate sequence of segmented words with a highest score from the candidate sequences of segmented words based on the path scores as the sequence of segmented words of the sentence.

The statistical language model may be selected based on an actual requirement. For example, the statistical language model may be an N-Gram model.

At block 103, a dependency tree graph among respective segmented words in the sequence of segmented words is obtained by performing a dependency parsing on the sequence of segmented words.

In some embodiments, the sequence of segmented words may be inputted into a preset dependency parsing model and the dependency parsing is performed on the sequence of segmented words by the dependency parsing model, to obtain the dependency tree graph among the segmented words in the sequence of segmented words.

The node in the dependency tree graph corresponds to each segmented word in the sequence of segmented words. There is also a dependency relationship between nodes in the dependency tree graph. The dependency relationship between the nodes is used to represent the dependency relationship between a segmented word and another segmented word.

The dependency relationship may include, but be not limited to, a subject-predicate relationship, a verb-object relationship, an inter-object relationship, a pre-object relationship, a concurrent language relationship, a centering relationship, an adverbial structure, a verb-complement structure, a juxtaposition relationship, a mediator-object relationship, an independent structure, and a core relationship. Embodiments do not specifically limit the dependency relationship herein.

At block 104, a word vector corresponding to each segmented word in the sequence of segmented words is determined.

In some embodiments, each segmented word in the sequence of segmented words may be represented by a vector through an existing word vector processing model, to obtain the word vector of each segmented word in the sequence of segmented words.

At block 105, the dependency tree graph and the word vector corresponding to each segmented word are inputted into a preset graph neural network to obtain an intermediate word vector of each segmented word in the sequence of segmented words.

It should be noted that, the graph neural network in embodiments may represent the dependency relationship between the segmented word and another segmented word based on the dependency tree graph and the word vector corresponding to each segmented word, to obtain the intermediate word vector of each segmented word. The intermediate word vector is obtained based on the dependency relationship.

The graph neural network (GNN) is a kind of neural network directly acting on a graph structure, which has been widely used in various fields such as a social network, a knowledge map, a recommendation system and even a life science. The GNN is a spatial-based graph neural network, and an attention mechanism of the GNN is configured to determine a weight of a neighborhood of the node when aggregating feature information. The input of the GNN network is a vector of each node and an adjacency matrix of the nodes.

Because a syntactic analysis result is a tree structure (the tree is a special structure of a graph), the syntactic analysis result may be represented by the graph neural network naturally. Therefore, the dependency parsing is performed on user data first to obtain a result, and the result is represented by the adjacency matrix. For example, taking a sentence “XX (a detailed company name in a practical application) is a high-tech company” as an example, the dependency parsing may be performed on the sentence by the dependency parsing model to obtain the dependency graph tree corresponding to the sentence. The dependency graph tree corresponding to the sentence may be represented in the form of the adjacency matrix, as illustrated in Table 1.

TABLE 1

| | X X | is | a | high-tech | company |
|---|---|---|---|---|---|
| X X | 1 | 1 | 0 | 0 | 0 |
| is | 1 | 1 | 0 | 0 | 1 |
| a | 0 | 0 | 1 | 0 | 1 |
| high-tech | 0 | 0 | 0 | 1 | 1 |
| company | 0 | 1 | 1 | 1 | 1 |

Characters in each unit on the left side of the table may represent a parent node, and characters in each unit on the top may represent a child node. When the value is 1, it means that there is an edge pointing from the parent node to the child node, and when it is 0, it means that the edge does not exist.

In some embodiments, although the edge between nodes in the syntactic analysis result is a directed edge, in order to avoid a sparsity of the adjacency matrix, the edge between nodes may be an undirected edge. Therefore, in some embodiments, there is no symmetric matrix for the adjacency matrix.

In some embodiments, in order to accurately determine the intermediate word vector of the corresponding segmented word based on a dependency relationship, the above graph neural network may also determine the intermediate word vector of the corresponding segmented word based on the graph neural network of the attention mechanism by combining an attention score of the dependency relationship in the graph neural network.

At block 106, a processing result of the sentence is obtained by performing the downstream task on the intermediate word vector of each segmented word.

With the method for processing the sentence according to embodiments of the disclosure, when the sentence is processed, the dependency tree graph among the respective segmented words in the sequence of segmented words of the sentence is obtained by performing the dependency parsing on the sequence of segmented words. The dependency tree graph and the word vector corresponding to each segmented word are inputted into the preset graph neural network to obtain the intermediate word vector of each segmented word in the sequence of segmented words. Then, the processing result of the sentence is obtained by performing the downstream task on the intermediate word vector of each segmented word. In this way, the intermediate word vector including the syntactic information is obtained, and the downstream task is processed based on the intermediate word vector including the syntactic information, such that the downstream task may accurately obtain the processing result of the sentence and improve the processing effect of the downstream task.

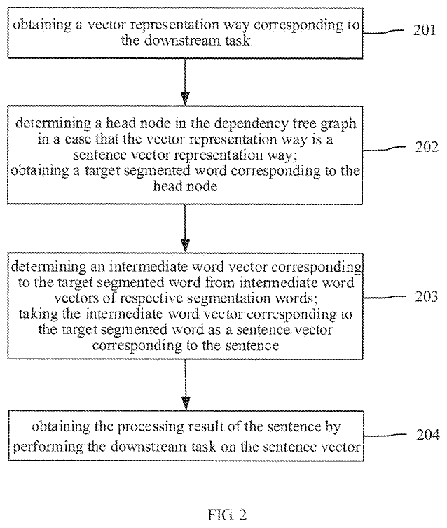

In some embodiments of the disclosure, it may be understood that, different types of downstream tasks perform different processing on the sentence, and different types of downstream tasks may need different vector representations. For example, some downstream tasks may need intermediate word vectors containing the syntactic information for subsequent processing, while other tasks may be combined with the vector of the sentence for subsequent processing. In some embodiments of the disclosure, in order to process the downstream task which needs the word vector, the obtaining the processing result of the sentence by performing the downstream task on the intermediate word vector of each segmented word at block, as illustrated in FIG. 2, may include following.

At block 201, a vector representation way corresponding to the downstream task is obtained.

In some embodiments, the vector representation way corresponding to the downstream task may be obtained based on a pre-stored correspondence between each downstream task and the vector representation way. The vector representation way, that is, a vector representation type, is divided into a word vector representation type and a sentence vector representation type.

In some embodiments, in order to conveniently obtain the vector representation way of the downstream task, a possible way for obtaining the vector representation way corresponding to the downstream task is obtaining a task type corresponding to the downstream task, and determining the vector representation way of the downstream task based on the task type.

In detail, the vector representation way corresponding to the task type may be obtained based on a correspondence between pre-stored task types and the vector representation ways, and the obtained vector representation way may be used as the vector representation way of the downstream task.

At block 202, a head node in the dependency tree graph is determined in a case that the vector representation way is the sentence vector representation way, and a target segmented word corresponding to the head node is obtained.

At block 203, an intermediate word vector corresponding to the target segmented word is determined from intermediate word vectors of respective segmentation words, and the intermediate word vector corresponding to the target segmented word is taken as a sentence vector corresponding to the sentence.

At block 204, the processing result of the sentence is obtained by performing the downstream task on the sentence vector.

In some embodiments, when the above downstream task may be a sentence classification task, a possible implementation way for obtaining the processing result of the sentence by performing the downstream task on the sentence vector is classifying the sentence vector based on the sentence classification task to obtain a classification result, and take the classification result as the processing result of the sentence to be processed.

It may be understood that, embodiments only take that the downstream task is the sentence classification task as an example, and the downstream task may be other tasks that need to be processed by the sentence vector. For example, the downstream task may also be a task such as sentence matching.

In some embodiments, when the vector representation way is the sentence vector representation way, the target segmented word corresponding to the head node is obtained by determining the head node in the dependency tree graph. The intermediate word vector corresponding to the target segmented word is determined based on the intermediate word vector of each segmented word. The intermediate word vector corresponding to the target segmented word is taken as the sentence vector corresponding to the sentence. Downstream task processing is performed based on the sentence vector. Since the sentence vector includes the syntactic information of the sentence, the accuracy of the downstream task processing may be improved, and the processing result of the sentence in the downstream task may be accurately obtained.

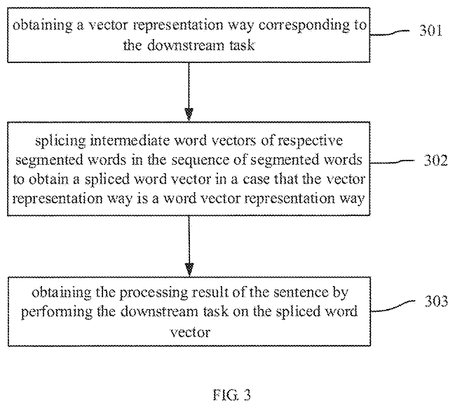

In some embodiments of the disclosure, in order to make it possible to accurately process the downstream task which needs the sentence vector of the sentence, as illustrated in FIG. 3, the obtaining the processing result of the sentence by performing the downstream task on the intermediate word vector of each segmented word at block 106 includes following.

At block 301, a vector representation way corresponding to the downstream task is obtained.

The detailed description of the implementation at block 301 may be referred to the related description of the above embodiments.

At block 302, intermediate word vectors of respective segmented words in the sequence of segmented words are spliced to obtain a spliced word vector in a case that the vector representation way is a word vector representation way.

At block 303, the processing result of the sentence is obtained by performing the downstream task on the spliced word vector.

In some embodiments, when the downstream task is an entity recognition task, a possible way for obtaining the processing result of the sentence by performing the downstream task on the spliced word vector is performing the entity recognition on the spliced word vector based on the entity recognition task to obtain an entity recognition result, and taking the entity recognition result as the processing result of the sentence to be processed.

It may be understood that, embodiments only take that the downstream task is the entity recognition task as an example, and the above downstream task may be other tasks that need the intermediate word vector for processing.

In some embodiments, in the case that the vector representation way is the word vector representation way, the intermediate word vectors of respective segmented words in the sequence of segmented words are spliced to obtain the spliced word vector, and the downstream task is performed on the spliced word vector to obtain the processing result of the sentence. Since the intermediate word vector contains the syntactic information, the corresponding spliced vector also includes the syntactic information. Performing the downstream task processing based on the spliced vector may improve the accuracy of the downstream task processing, thereby accurately obtaining the processing result of the sentence in the downstream task.

In order to implement the above embodiments, embodiments of the disclosure also provide an apparatus for processing a sentence.

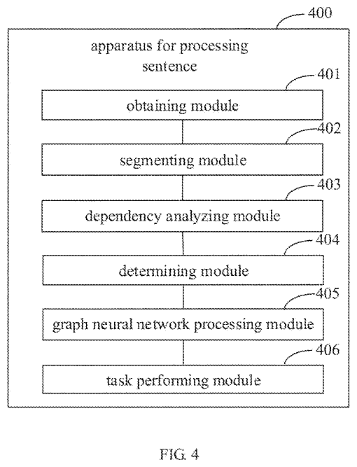

FIG. 4 is a block diagram illustrating an apparatus for processing a sentence according to some embodiments of the disclosure.

As illustrated in FIG. 4, the apparatus 400 for processing the sentence may also include: an obtaining module 401, a segmenting module 402, a dependency analyzing module 403, a determining module 404, a graph neural network processing module 405, and a task performing module 406.

The obtaining module 401 is configured to obtain a sentence to be processed, and to obtain a downstream task to be executed for the sentence.

The segmenting module 402 is configured to obtain a sequence of segmented words of the sentence by performing a word segmentation on the sentence.

The dependency analyzing module 403 is configured to obtain a dependency tree graph among respective segmented words in the sequence of segmented words by performing a dependency parsing on the sequence of segmented words.

The determining module 404 is configured to determine a word vector corresponding to each segmentation word in the sequence of segmented words.

The graph neural network processing module 405 is configured to input the dependency tree graph and the word vector corresponding to each segmented word into a preset graph neural network to obtain an intermediate word vector of each segmented word in the sequence of segmented words.

The task performing module 406 is configured to obtain a processing result of the sentence by performing the downstream task on the intermediate word vector of each segmented word.

It should be noted that, the above explanation for embodiments of the method for processing the sentence is also applicable to some embodiments, which is not elaborated in some embodiments.

With the apparatus for processing the sentence according to embodiments of the disclosure, when the sentence is processed, the dependency tree graph among the respective segmented words in the sequence of segmented words is obtained by performing the dependency parsing on the sequence of segmented words. The dependency tree graph and the word vector corresponding to each segmented word are inputted into the preset graph neural network to obtain the intermediate word vector of each segmented word in the sequence of segmented words. Then, the processing result of the sentence is obtained by performing the downstream task on the intermediate word vector of each segmented word. In this way, the intermediate word vector including the syntactic information is obtained, and the downstream task is processed based on the intermediate word vector including the syntactic information, such that the downstream task may accurately obtain the processing result of the sentence and improve the processing effect of the downstream task.

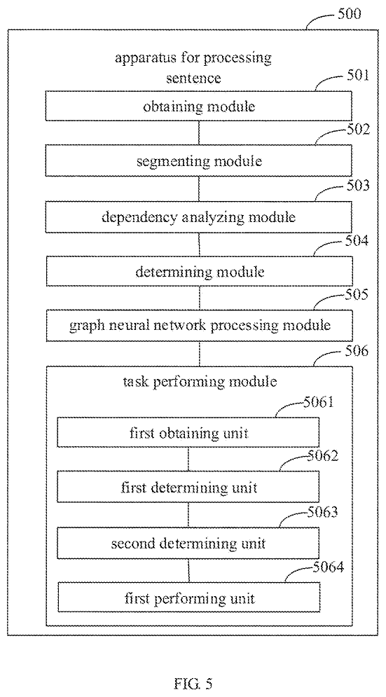

In some embodiments of the disclosure, as illustrated in FIG. 5, the apparatus for processing the sentence may include: an obtaining module 501, a segmenting module 502, a dependency analyzing module 503, a determining module 504, a graph neural network processing module 505, and a task performing module 506. The task performing module 506 may include: a first obtaining unit 5061, a first determining unit 5062, a second determining unit 5063, and a first performing unit 5064.

For detailed description for the obtaining module 501, the segmenting module 502, the dependency analyzing module 503, the determining module 504, and the graph neural network processing module 505, please refer to the description for the obtaining module 401, the segmenting module 402, the dependency analyzing module 403, the determining module 404, and the graph neural network processing module 405 in embodiments illustrated in FIG. 4, which is not elaborated herein.

The first obtaining unit 5061 is configured to obtain a vector representation way corresponding to the downstream task.

The first determining unit 5062 is configured to determine a head node in the dependency tree graph in a case that the vector representation way is a sentence vector representation way, and to obtain a target segmented word corresponding to the head node.

The second determining unit 5063 is configured to determine an intermediate word vector corresponding to the target segmented word from intermediate word vectors of respective segmentation words, and to take the intermediate word vector corresponding to the target segmented word as a sentence vector corresponding to the sentence.

The first performing unit 5064 is configured to obtain the processing result of the sentence by performing the downstream task on the sentence vector.

In some embodiments of the disclosure, obtaining the vector representation corresponding to the downstream task includes: obtaining a task type corresponding to the downstream task; and determining the vector representation way of the downstream task based on the task type.

In some embodiments of the disclosure, the downstream task is a sentence classification task. The first performing unit is configured to: classify the sentence vector based on the sentence classification task to obtain a classification result, and take the classification result as the processing result of the sentence.

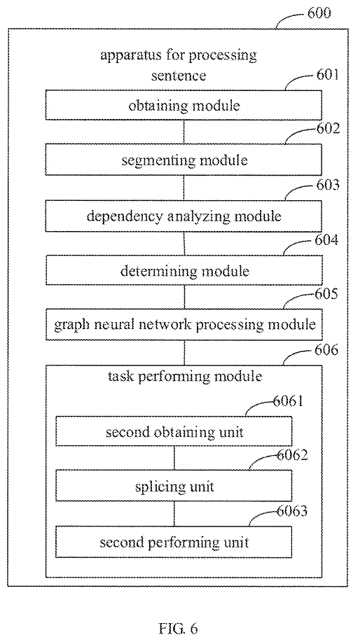

In some embodiments of the disclosure, as illustrated in FIG. 6, the apparatus for processing the sentence may include: an obtaining module 601, a segmenting module 602, a dependency analyzing module 603, a determining module 604, a graph neural network processing module 605, and a task performing module 606. The task performing module 606 includes: a second obtaining unit 6061, a splicing unit 6062, and a second performing unit 6063.

For detailed description for the obtaining module 601, the segmenting module 602, the dependency analyzing module 603, the determining module 604, and the graph neural network processing module 605, please refer to the description for the obtaining module 401, the segmenting module 402, the dependency analyzing module 403, the determining module 404, and the graph neural network processing module 405 in embodiments illustrated in FIG. 4, which is not elaborated herein.

In some embodiments of the disclosure, the second obtaining unit 6061 is configured to obtain a vector representation way corresponding to the downstream task.

The splicing unit 6062 is configured to splice intermediate word vectors of respective segmentation words in the sequence of segmented words to obtain a spliced word vector in a case that the vector representation way is a word vector representation way.

The second performing unit 6063 is configured to obtain the processing result of the sentence by performing the downstream task on the spliced word vector.

In some embodiments of the disclosure, the downstream task is an entity recognition task. The second performing unit 6043 is configured to: perform an entity recognition on the spliced word vector based on the entity recognition task to obtain an entity recognition result, and take the entity recognition result as the processing result of the sentence.

It should be noted that, the above explanation for embodiments of the method for processing the sentence is also applicable to the apparatus for processing the sentence in some embodiments, which is not elaborated here.

According to embodiments of the disclosure, the disclosure also provides an electronic device, a readable storage medium, and a computer program product.

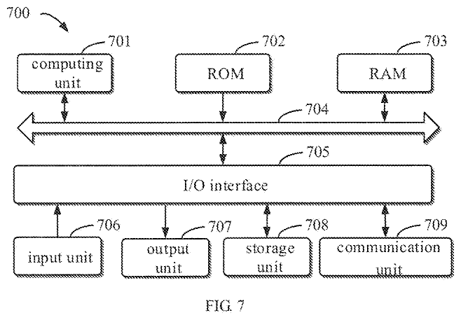

FIG. 7 is a block diagram illustrating an exemplary electronic device 700 capable of implementing embodiments of the disclosure. The electronic device aims to represent various forms of digital computers, such as a laptop computer, a desktop computer, a workstation, a personal digital assistant, a server, a blade server, a mainframe computer and other suitable computer. The electronic device may also represent various forms of mobile devices, such as personal digital processing, a cellular phone, a smart phone, a wearable device and other similar computing device. The components, connections and relationships of the components, and functions of the components illustrated herein are merely examples, and are not intended to limit the implementation of the disclosure described and/or claimed herein.

As illustrated in FIG. 7, the device 700 includes a computing unit 701, which may execute various appropriate acts and processing based on a computer program stored in a read-only memory (ROM) 702 or a computer program loaded from a storage unit 708 to a random-access memory (RAM) 703. In the RAM 703, various programs and data needed for the operation of the device 700 may be stored. The CPU 701, the ROM 702, and the RAM 703 are connected to each other through a bus 704. An input/output (I/O) interface 705 is also connected to the bus 704.

Multiple components in the device 700 are connected to the I/O interface 705, including: an input unit 706, such as a keyboard, a mouse, etc.; an output unit 707, such as various types of displays, speakers, etc.; the storage unit 708, such as a disk, a CD, etc.; and a communication unit 709, such as a network card, a modem, a wireless communication transceiver, etc. The communication unit 709 allows the device 700 to exchange information/data with other devices via computer networks such as the Internet and/or various telecommunications networks.

The computing unit 701 may be various general-purpose and/or special-purpose processing components with processing and computing capabilities. Some examples of the computing unit 701 include, but are not limited to, a central processing unit (CPU), a graphics processing unit (GPU), various dedicated artificial intelligence (AI) computing chips, various computing units for running machine learning model algorithms, a digital signal processor (DSP), and any suitable processor, controller, microcontroller, etc. The computing unit 701 executes various methods and processes described above, such as the method for processing the sentence. For example, in some embodiments, the method for processing the sentence may be implemented as a computer software program tangibly embodied in a machine-readable medium, such as the storage unit 708. In some embodiments, part or all of the computer program may be loaded and/or installed on the device 700 via the ROM 702 and/or the communication unit 709. When the computer program is loaded into the RAM 703 and executed by the computing unit 701, one or more acts of the method for processing the sentence described above may be executed. Alternatively, in other embodiments, the computing unit 701 may be configured to execute the method for processing the sentence by any other suitable means (for example, by means of firmware).

Various embodiments of the systems and techniques described above herein may be implemented in a digital electronic circuit system, an integrated circuit system, a field programmable gate array (FPGA), an application specific integrated circuit (ASIC), an application specific standard product (ASSP), a system on a chip (SOC), a load programmable logic device (CPLD), computer hardware, firmware, software, and/or combinations thereof. These various embodiments may include being implemented in one or more computer programs. The one or more computer programs may be executed and/or interpreted on a programmable system including at least one programmable processor. The programmable processor may be a special-purpose or general-purpose programmable processor and may receive data and instructions from a storage system, at least one input device, and at least one output device, and transmit data and instructions to the storage system, the at least one input device, and the at least one output device.

The program codes for implementing the method of embodiments of the disclosure may be written in any combination of one or more program languages. These program codes may be provided for a processor or a controller of a general-purpose computer, a special-purpose computer, or other programmable data-processing devices, such that the functions/operations regulated in the flow charts and/or block charts are implemented when the program codes are executed by the processor or the controller. The program codes may be completely executed on the machine, partly executed on the machine, partly executed on the machine as a standalone package and partly executed on a remote machine or completely executed on a remote machine or a server.

In the context of the disclosure, the machine readable medium may be a tangible medium, which may include or store the programs for use of an instruction execution system, apparatus or device or for use in conjunction with the instruction execution system, apparatus or device. The machine readable medium may be a machine readable signal medium or a machine readable storage medium. The machine readable medium may include but not limited to electronic, magnetic, optical, electromagnetic, infrared, or semiconductor systems, apparatuses or devices, or any appropriate combination of the foregoing contents. A more detailed example of the machine readable storage medium includes electrical connections based on one or more lines, a portable computer disk, a hard disk, a random access memory (RAM), a read-only memory (ROM), an erasable programmable read only memory (an EPROM or a flash memory), an optical fiber, a compact disc read-only memory (CD-ROM), an optical storage device, a magnetic storage device, or any appropriate combination of the above contents.

In order to provide interaction with a user, the systems and technologies described herein may be implemented on a computer. The computer has a display device (e.g., a CRT (cathode ray tube) or LCD (liquid crystal display) monitor) for displaying information to the user, a keyboard and pointing device (e.g., a mouse or trackball). The user may provide input to the computer through the keyboard and the pointing device. Other kinds of devices may also be used to provide interaction with users. For example, a feedback provided to the user may be any form of sensory feedback (e.g., a visual feedback, an auditory feedback, or a tactile feedback), and may receive input from the user in any form (including acoustic input, voice input, or tactile input).

The systems and technologies described herein may be implemented in a computing system (e.g., as a data server) including a background component, a computing system (e.g., an application server) including a middleware component, a computing system including a front-end component (e.g., a user computer having a graphical user interface or a web browser, through which the user may interact with embodiments of the systems and technologies described herein), or a computing system including any combination of such background component, middleware component, or front-end component). Components of the system may be connected to each other by digital data communication (such as a communication network) in any form or medium. Examples of the communication network include a local area network (LAN), a wide area network (WAN), the Internet, and a block chain network.

The computer system may include a client and a server. The client and the server are generally remote from each other and typically interact via the communication network. A client-server relationship is generated by computer programs operating on corresponding computers and having the client-server relationship with each other. The server may be a cloud server, also known as a cloud computing server or a cloud host. The server is a host product in a cloud computing service system, to solve defects of difficult management and weak business scalability in a conventional physical host and a VPS service (“virtual private server”). The server may also be a server of a distributed system or a server combined with a blockchain.

It should be noted that, artificial intelligence is a subject that studies how to use the computer to simulate thinking processes and intelligent behaviors (such as learning, reasoning, thinking, planning, etc.) of people, which includes both hardware-level technologies and software-level technologies. Artificial intelligence hardware technologies generally include technologies such as sensors, special artificial intelligence chips, cloud computing, distributed storage, and big data processing. Artificial intelligence software technologies mainly include computer vision technology, speech recognition technology, natural language processing technology, machine learning/deep learning, big data processing technology, knowledge map technology and so on.

It should be understood that steps may be reordered, added or deleted using various forms of processes illustrated above. For example, each step described in the disclosure may be executed in parallel, sequentially or in different orders, so long as a desired result of the technical solution disclosed in the disclosure may be achieved, which is not limited here.

The above detailed embodiments do not limit the protection scope of the disclosure. Those skilled in the art may understand that various modifications, combinations, sub-combinations and substitutions may be made according to design requirements and other factors. Any modification, equivalent substitution and improvement made within the principles of the disclosure shall be included in the protection scope of the disclosure.

What is claimed is:

1. A method for processing a sentence, comprising:
obtaining a sentence to be processed;
obtaining a downstream task to be executed for the sentence;
obtaining a sequence of segmented words of the sentence by performing a word segmentation on the sentence;
obtaining a dependency tree graph among respective segmented words in the sequence of segmented words by performing a dependency parsing on the sequence of segmented words;
determining a word vector corresponding to each segmented word in the sequence of segmented words;
inputting the dependency tree graph and the word vector corresponding to each segmented word into a preset graph neural network to obtain an intermediate word vector of each segmented word in the sequence of segmented words; and
obtaining a processing result of the sentence by performing the downstream task on the intermediate word vector of each segmented word.

2. The method of claim 1, wherein obtaining the processing result of the sentence by performing the downstream task on the intermediate word vector of each segmented word comprises:
obtaining a vector representation way corresponding to the downstream task;
determining a head node in the dependency tree graph in a case that the vector representation way is a sentence vector representation way;
obtaining a target segmented word corresponding to the head node;
determining an intermediate word vector corresponding to the target segmented word from intermediate word vectors of respective segmentation words;
taking the intermediate word vector corresponding to the target segmented word as a sentence vector corresponding to the sentence; and
obtaining the processing result of the sentence by performing the downstream task on the sentence vector.

3. The method of claim 1, wherein obtaining the processing result of the statement by performing the downstream task on the intermediate word vector of each segmentation word comprises:
obtaining a vector representation way corresponding to the downstream task;
splicing intermediate word vectors of respective segmented words in the sequence of segmented words to obtain a spliced word vector in a case that the vector representation way is a word vector representation way; and
obtaining the processing result of the sentence by performing the downstream task on the spliced word vector.

4. The method of claim 2, wherein obtaining the vector representation way corresponding to the downstream task comprises:
obtaining a task type corresponding to the downstream task; and
determining the vector representation way of the downstream task based on the task type.

5. The method of claim 2, wherein the downstream task is a sentence classification task, and obtaining the processing result of the sentence by performing the downstream task on the sentence vector comprises:
classifying the sentence vector based on the sentence classification task to obtain a classification result, and taking the classification result as the processing result of the sentence.

6. The method of claim 3, wherein the downstream task is an entity recognition task, and obtaining the processing result of the sentence by performing the downstream task on the spliced word vector comprises:
performing an entity recognition on the spliced word vector based on the entity recognition task to obtain an entity recognition result, and taking the entity recognition result as the processing result of the sentence.

7. An electronic device, comprising:
at least one processor; and
a memory, communicatively coupled to the at least one processor,
wherein the memory is configured to store instructions executable by the at least one processor, and when the instructions are executed by the at least one processor, the at least one processor is caused to:
obtain a sentence to be processed;
obtain a downstream task to be executed for the sentence;
obtain a sequence of segmented words of the sentence by performing a word segmentation on the sentence;
obtain a dependency tree graph among respective segmented words in the sequence of segmented words by performing a dependency parsing on the sequence of segmented words;
determine a word vector corresponding to each segmented word in the sequence of segmented words;
input the dependency tree graph and the word vector corresponding to each segmented word into a preset graph neural network to obtain an intermediate word vector of each segmented word in the sequence of segmented words; and
obtain a processing result of the sentence by performing the downstream task on the intermediate word vector of each segmented word.

8. The electronic device of claim 7, wherein when the instructions are executed by the at least one processor, the at least one processor is caused to:
obtain a vector representation way corresponding to the downstream task;
determine a head node in the dependency tree graph in a case that the vector representation way is a sentence vector representation way;
obtain a target segmented word corresponding to the head node;
determine an intermediate word vector corresponding to the target segmented word from intermediate word vectors of respective segmentation words;
take the intermediate word vector corresponding to the target segmented word as a sentence vector corresponding to the sentence; and
obtain the processing result of the sentence by performing the downstream task on the sentence vector.

9. The electronic device of claim 7, wherein when the instructions are executed by the at least one processor, the at least one processor is caused to:
obtain a vector representation way corresponding to the downstream task;
splice intermediate word vectors of respective segmented words in the sequence of segmented words to obtain a spliced word vector in a case that the vector representation way is a word vector representation way; and
obtain the processing result of the sentence by performing the downstream task on the spliced word vector.

10. The electronic device of claim 8, wherein when the instructions are executed by the at least one processor, the at least one processor is caused to:
obtain a task type corresponding to the downstream task; and
determine the vector representation way of the downstream task based on the task type.

11. The electronic device of claim 8, wherein the downstream task is a sentence classification task, and when the instructions are executed by the at least one processor, the at least one processor is caused to:
classify the sentence vector based on the sentence classification task to obtain a classification result, and take the classification result as the processing result of the sentence.

12. The electronic device of claim 9, wherein the downstream task is an entity recognition task, and when the instructions are executed by the at least one processor, the at least one processor is caused to:
perform an entity recognition on the spliced word vector based on the entity recognition task to obtain an entity recognition result, and take the entity recognition result as the processing result of the sentence.

13. A non-transitory computer readable storage medium having computer instructions stored thereon, wherein the computer instructions are configured to cause a computer to execute a method, the method comprising:
obtaining a sentence to be processed;
obtaining a downstream task to be executed for the sentence;
obtaining a sequence of segmented words of the sentence by performing a word segmentation on the sentence;
obtaining a dependency tree graph among respective segmented words in the sequence of segmented words by performing a dependency parsing on the sequence of segmented words;
determining a word vector corresponding to each segmented word in the sequence of segmented words;
inputting the dependency tree graph and the word vector corresponding to each segmented word into a preset graph neural network to obtain an intermediate word vector of each segmented word in the sequence of segmented words; and
obtaining a processing result of the sentence by performing the downstream task on the intermediate word vector of each segmented word.

14. The non-transitory computer readable storage medium of claim 13, wherein obtaining the processing result of the sentence by performing the downstream task on the intermediate word vector of each segmented word comprises:
obtaining a vector representation way corresponding to the downstream task;
determining a head node in the dependency tree graph in a case that the vector representation way is a sentence vector representation way;
obtaining a target segmented word corresponding to the head node;
determining an intermediate word vector corresponding to the target segmented word from intermediate word vectors of respective segmentation words;
taking the intermediate word vector corresponding to the target segmented word as a sentence vector corresponding to the sentence; and
obtaining the processing result of the sentence by performing the downstream task on the sentence vector.

15. The non-transitory computer readable storage medium of claim 13, wherein obtaining the processing result of the statement by performing the downstream task on the intermediate word vector of each segmentation word comprises:
obtaining a vector representation way corresponding to the downstream task;
splicing intermediate word vectors of respective segmented words in the sequence of segmented words to obtain a spliced word vector in a case that the vector representation way is a word vector representation way; and
obtaining the processing result of the sentence by performing the downstream task on the spliced word vector.

16. The non-transitory computer readable storage medium of claim 14, wherein obtaining the vector representation way corresponding to the downstream task comprises:
obtaining a task type corresponding to the downstream task; and
determining the vector representation way of the downstream task based on the task type.

17. The non-transitory computer readable storage medium of claim 14, wherein the downstream task is a sentence classification task, and obtaining the processing result of the sentence by performing the downstream task on the sentence vector comprises:
classifying the sentence vector based on the sentence classification task to obtain a classification result, and taking the classification result as the processing result of the sentence.

18. The non-transitory computer readable storage medium of claim 15, wherein the downstream task is an entity recognition task, and obtaining the processing result of the sentence by performing the downstream task on the spliced word vector comprises:
performing an entity recognition on the spliced word vector based on the entity recognition task to obtain an entity recognition result, and taking the entity recognition result as the processing result of the sentence.
